(19) United States
(12) Patent Application Publication
(10) Pub. No.: US 2006/0095313 A1
(43) Pub. Date: May 4, 2006

(54) Evaluating input ambiguity in a work system

(76) Inventors: Jan S. Benson, Royal Oak, MI (US); William C. Jordan, Beverly Hills, MI (US); Hallie J. Kintner, Ann Arbor, MI (US); Susan H. Owen, Beverly Hills, MI (US); Daniel J. Reaume, Livonia, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 10/979,016

(22) Filed: Nov. 1, 2004

(51) Int. Cl. G07G 1/00

(52) U.S. Cl. 705/10

(57) ABSTRACT

A method is provided for evaluating input ambiguity in a work system. The method includes receiving a response to a questionnaire from a person. The questionnaire includes a plurality of questions related to an input ambiguity characteristic. The questions include: whether inputs to a work task are available; whether the inputs to the work task are identified; whether work task resources are identified when the work task is started; whether the work task resources are available when the work task is started; and whether customer requirements are understood. A score is computed for the questions using the response from the person and the questionnaire as input.

### BACKGROUND OF THE INVENTION

The present disclosure relates generally to a method of categorizing work, and, in particular, to a method of interpreting the results of a questionnaire to determine a score on one or more characteristics related to work performed by a person or a group of people.

Some of the most effective principles for manufacturing work focus on managing variability to achieve improved system performance. Manufacturing work is typically modeled as a network of workstations that together make up a production line. Jobs flow through the line according to some routing to produce an end item. A bill of material can be used to document the relationships between the end item and its component parts. The outputs of a manufacturing system are predefined and well specified, so that the amount and type of work to be done at each workstation is fully understood. This is not to say that the processing at a workstation is deterministic, because most manufacturing lines face variation in processing times as well as uncertainty in failure rates and repair times. Rather, the assumption is that a person working in a manufacturing setting knows exactly what inputs are requires to begin processing a job and what work needs to be accomplished at each workstation. The worker is thus able to identify when processing on a part can begin and when it is completed. In such a manufacturing environment, the quality of an output can be measured by the degree to which it adheres to pre-defined specifications.

Queuing based approaches to improving work system performance have been successfully applied to improve productivity in manufacturing environments. However, attempts to apply queuing concepts and related modeling methods to some types of work (e.g., white collar work such as engineering) may not result in an appreciable improvement in productivity. One reason is that some types of work do not include well-defined inputs, outputs or processes for performing the work.

### BRIEF DESCRIPTION OF THE INVENTION

According to one aspect of the invention, a method is provided for evaluating input ambiguity. The method includes receiving a response to a questionnaire from a person. The questionnaire includes a plurality of questions related to an input ambiguity characteristic. The questions include: whether inputs to a work task are available; whether the inputs to the work task are identified; whether work task resources are identified when the work task is started; whether the work task resources are available when the work task is started; and whether customer requirements are understood. A score is computed for the questions using the response from the person and the questionnaire as input.

In a further aspect, a computer program product is provided for evaluating input ambiguity. The computer program product includes a storage medium readable by a processing circuit and storing instructions for execution by the processing circuit for performing a method. The method includes receiving a response to a questionnaire from a person. The questionnaire includes a plurality of questions related to an input ambiguity characteristic. The questions include: whether inputs to a work task are available; whether the inputs to the work task are identified; whether work task resources are identified when the work task is started; whether the work task resources are available when the work task is started; and whether customer requirements are understood. A score is computed for the questions using the response from the person and the questionnaire as input.

In another aspect, a system is provided for evaluating input ambiguity. The system includes a host system in communication with a user system. The host system includes instructions for receiving a response to a questionnaire from a person via the user system. The questionnaire includes a plurality of questions related to an input ambiguity characteristic. The questions include: whether inputs to a work task are available; whether the inputs to the work task are identified; whether work task resources are identified when the work task is started; whether the work task resources are available when the work task is started; and whether customer requirements are understood. A score is computed for the questions using the response from the person and the questionnaire as input.

### BRIEF DESCRIPTION OF THE DRAWINGS

Referring to the exemplary drawings wherein like elements are numbered alike in the several FIGURES:

FIG. 1 is a block diagram of an exemplary process for categorizing work;

FIG. 2 is an exemplary user interface screen for applying a questionnaire in accordance with exemplary embodiments of the present invention;

FIG. 3 is an exemplary user interface screen for applying a questionnaire in accordance with exemplary embodiments of the present invention;

FIG. 4 is a chart containing attributes associated with exemplary factors;

FIG. 5 contains principles that may be applied to a factor related to routineness;

FIG. 6 contains principles that may be applied to a factor related to input ambiguity;

FIG. 7 contains principles that may be applied to a factor related to output ambiguity;

FIG. 8 contains principles that may be applied to a factor related to initiative;

FIG. 9 contains principles that may be applied to a factor related to complexity; and

FIG. 10 is a block diagram of an exemplary system for categorizing work.

### DETAILED DESCRIPTION OF THE INVENTION

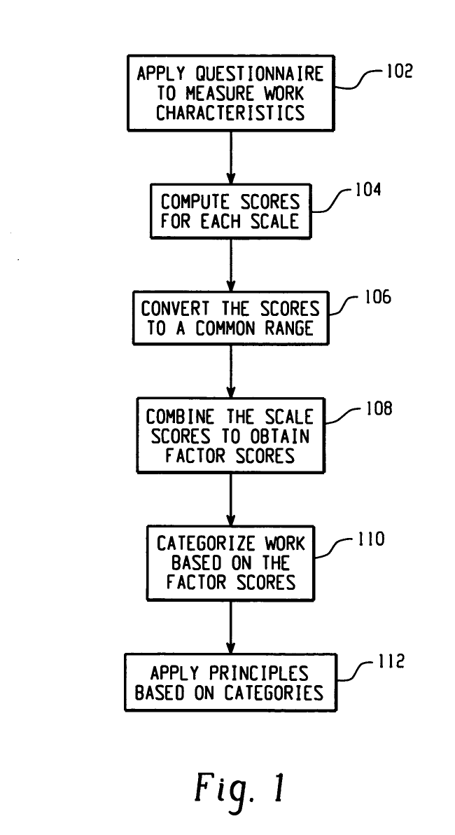

FIG. 1 is a block diagram of an exemplary process for categorizing work in terms of various characteristics of the work process and/or the work environment. As used herein, the term “characteristics” refers to characteristics that may be utilized to classify different types of work. Characteristics may include, but are not limited to, creativity, exceptions, analyzability, goal ambiguity, worker initiative, input ambiguity, task difficulty, interdependence, autonomy, interaction intensity, and feedback. Creativity refers to the degree to which the work output is something new to the people who use it and is valuable to themselves or to others. Exceptions refer to the degree of time spent applying different methods and/or procedures for performing the work. Analyzability refers to the degree of definition of the sequences, procedures and practices for performing a work task. Goal ambiguity is the degree to which the outcome goals and objectives of the work are clearly stated and well defined. Worker initiative is focused on how much discretion the worker has in determining what to work on, when to start and what inputs are required.

Another characteristic is input ambiguity which is the degree to which the inputs required to execute a task are available to a worker without the need to determine what the inputs are, determine if they are available, and/or acquire them. Task difficulty refers to the amount of cognitive ability required to perform the task. Interdependence is the degree to which workers must rely on or collaborate with others to complete their work. Autonomy is the degree to which the job provides substantial freedom, independence and discretion to the person in scheduling work and in determining the procedures to be used in carrying it out. Interaction intensity is the amount and intensity of interaction with customers or clients required to complete a job. Feedback is the degree to which carrying out the work tasks required by the job results in the person obtaining direct and clear information about the effectiveness of his or her performance. The characteristics described herein are intended to be exemplary in nature and therefore a subset and/or superset of these characteristics may be measured without departing from the scope of the invention.

Referring to FIG. 1, at block 102 a questionnaire is applied to measure work characteristics, such as the ones described above. In an exemplary embodiment of the present invention, the questionnaire is administered to people electronically via a computer system. The person is asked a set of questions about the nature of their work. In an alternate exemplary embodiment, the questionnaire (also referred to herein as a survey) is administered via an in person or over the telephone interview with the person. The term “person” as used herein refers to an individual who creates a work product for the company requesting the questionnaire, including but not limited to, a regular employee, a sub-contractor, a consultant and a vendor. The questionnaire includes a series of questions designed to measure the work characteristics. The questions within the questionnaire may be newly developed or adapted from existing scales that are known in the art. As used herein, the term “scale” refers to an instrument for measuring a characteristic. One or more scales (each scale including one or more questions relating to a characteristic) are combined to form a questionnaire to be administered to people. In addition, scales may be modified based on the results of measuring the effectiveness of the questionnaire.

Questions in a scale relating to the creativity characteristic may include: 1. My job requires original ideas; 2. My job is stimulating; 3. My job requires a fresh perspective on old problems; and 4. My job requires me to take the risk of doing things differently.

Questions in a scale relating to the exceptions characteristic may include: 1. My work is routine; 2. Routine work appears on my annual objectives; 3. I do about the same job in the same way most of the time; 4. Basically, I perform repetitive activities in doing my job; and 5. My work tasks are the same from day to day.

Questions in a scale relating to the analyzability characteristic may include: 1. There is an understandable sequence of steps that can be followed in doing my work; 2. To do my work, I actually rely on established procedures and practices; and 3. There are steps that define when I have completed an output.

Questions in a scale relating to the goal ambiguity characteristic may include: 1. My duties and responsibilities are well defined; 2. The goals and objectives of my job are well defined; 3. How my work relates to the overall objectives of my work unit are well defined; 4. The expected results of my work are well defined; and 5. What aspects of my work that will lead to positive evaluations are well defined.

Questions in a scale relating to the worker initiative characteristic may include: 1. I determine when to start working on specific tasks; 2. Others determine my task priorities; 3. A larger process determines when I start my work tasks; and 4. My supervisor tells me when to start my work tasks. For much white-collar work, the initiation process is not well defined and involves the discretion of the worker as to what to work on, when to start, and what inputs are required. The questions within this scale, relating to the worker initiative characteristic, do not assume that there is a well-defined process for delivering input. The questions are aimed at determining how much, if any, definition the process for initiating work contains.

Questions in a scale relating to the input ambiguity characteristic may include: 1. Everything I need to do my work is readily available; 2. I can quickly identify what I need to do my work; 3. When I start a work task, I know what resources I will need to complete it; 4. When I start a work task, I have the resources I will need to complete it; and 5. I can quickly understand what my customer wants. The questions within this scale do not focus on strategies to use when inputs are ambiguous, but instead focus on assessing the degree of ambiguity.

Questions in a scale relating to the task difficulty characteristic may include: 1. The amount of information I must attend to in order to perform my job is fairly minimal; 2. The amount of information I must create on this job is fairly minimal; 3. The amount of information I must process, in terms of thinking and problem solving is fairly minimal; and 4. The amount of information I must remember on my job is fairly minimal.

Questions in a scale relating to the interdependence characteristic may include: 1. I have to coordinate work with others; 2. Dealing with other people is part of my job; 3. My success depends on cooperation from others; and 4. I rely on people in other groups or departments.

Questions in a scale relating to the autonomy characteristic may include: 1. The job gives me a chance to use my personal initiative or judgment in carrying out the work; 2. The job gives me considerable opportunity for independence and freedom in how I do the work; and 3. To what extent does your job permit you to decide on your own how to go about doing the work.

Questions in a scale relating to the interaction intensity characteristic may include: 1. To what degree do you interpret the meaning of information for others; 2. How much communication with supervisors, peers or subordinates does your job require; 3. How much do you communicate with people in other organizations (i.e., people who report to other executives); 4. How much of your job requires influencing others; and 5. How much time do you spend resolving conflicts and negotiating with others?

Questions in a scale relating to the feedback attribute may include: 1. Just doing the work required by the job provides many chances for me to figure out how well I am doing; 2. After I finish a job, I know whether I performed well; and 3. To what extent does the job itself provide you with information about your work performance?

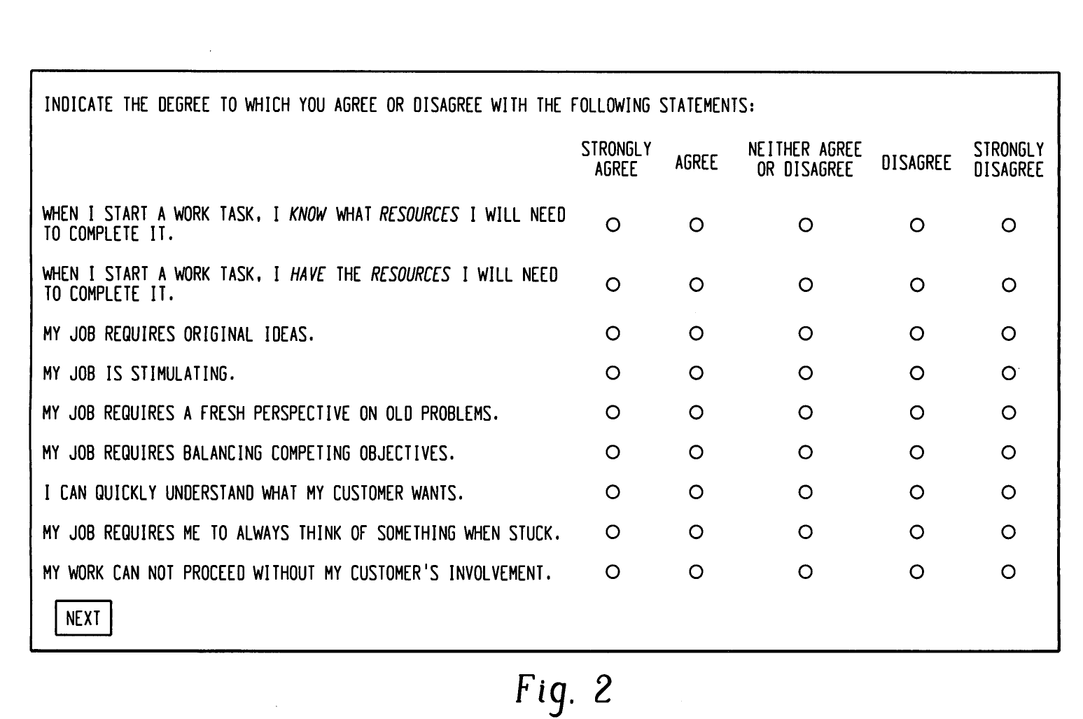

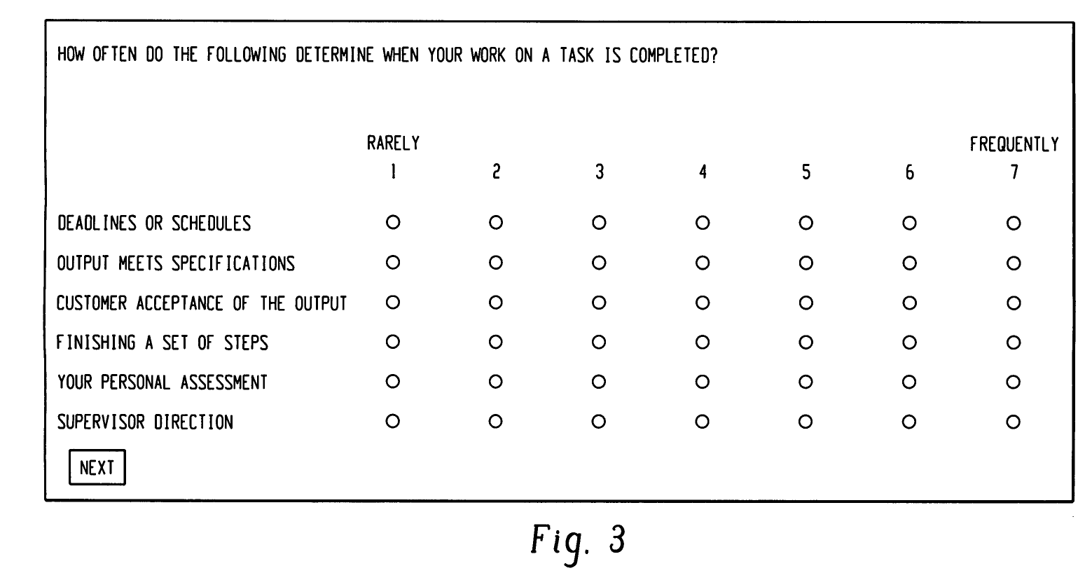

FIGS. 2 and 3 depict sample user interface screens for applying a questionnaire in accordance with exemplary embodiments of the present invention.

The scales (i.e., groups of one or more questions relating to a characteristic) within a questionnaire may be validated by applying them to a subset of the target people (i.e., a test group). One method of validating that the questions within a particular scale measure the same concept is to look at Cronbach-alpha values for the scale. The Cronbach-alpha value is a measure of the reliability of the scale. As is known in the art, a Cronbach-alpha score of “0.7” or higher indicates a strong correlation. Questions within individual scales may be adjusted based on the Cronbach-alpha score and retested. Any tools that will result in improving the reliability or validity of the questionnaire may be utilized by exemplary embodiments of the present invention.

Referring to block 104 in FIG. 1, the scores for each characteristic are computed. If the survey, or questionnaire, was administered to a group of people thought to have common job characteristics, the average score for the group may be computed. In addition, the average score for a single person may be computed and reported to the person. The scores may be computed based on each question having the same weight or certain questions may be given a higher weight than other questions.

Next, at block 106, the scores for each characteristic are converted to a common range. This process will be performed when the questionnaires for individual characteristics are scored on different ranges. For example, the goal ambiguity characteristic scale may be scored on a range from one to five and the feedback characteristic scale may be scored on a range from one to six. At 106, these scores are converted to a common range, such as a range from zero to one hundred.

At block 108, the scores for the characteristics are combined into a smaller set of factors. As used herein, the term “factor” refers to a group of characteristics. In general, several characteristics may be highly correlated and an exploratory factor analysis may be performed on the questionnaire results in order to group the various characteristics into a smaller and more manageable number of factors. A statistical analysis may be performed to validate the resulting factors. Confirmatory factor analysis and multidimensional scaling are examples of two other methods to do this analysis. Grouping the characteristics into factors may make the results easier for an individual to interpret and may be utilized to identify a directed group of principles that may be applied to increase worker productivity. As used herein the term “principle” refers to guidelines for worker (including manager) actions and decisions to improve work system performance, based on the laws or facts underlying the work system.

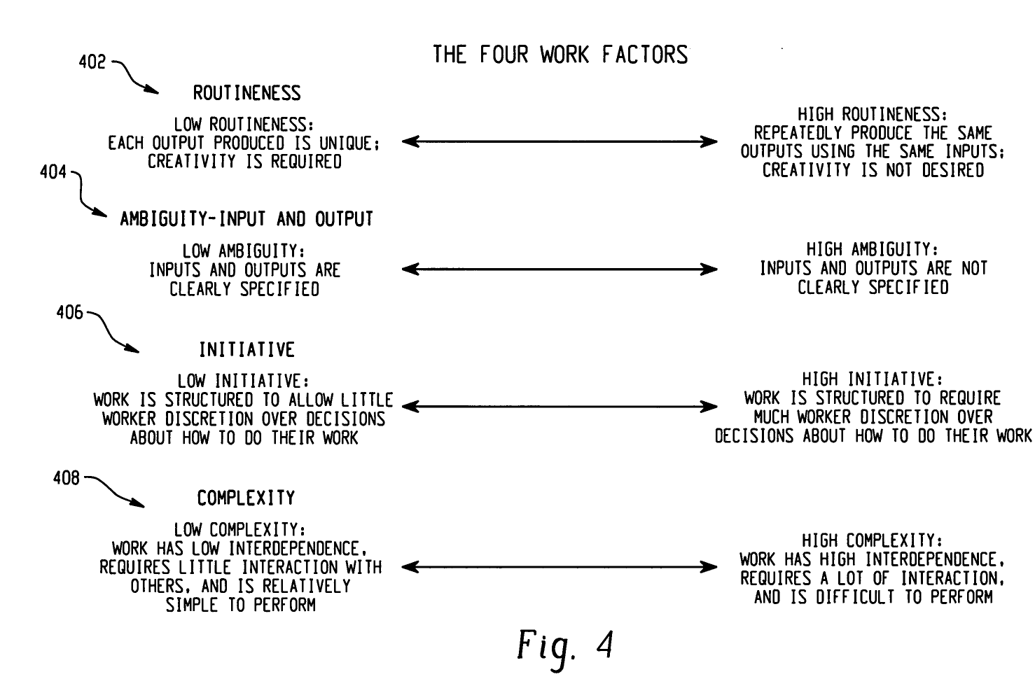

FIG. 4 is a chart containing attributes associated with four exemplary factors. The first factor, the routineness factor 402, includes the exceptions, creativity and analyzability characteristics. A high value associated with the routineness factor 402 indicates that the worker repeatedly produces the same outputs using the same inputs and that creativity is not desired. In contrast, a low value of the routineness factor 402 indicates that each output produced by the worker is unique and that creativity is required. The second factor, the ambiguity factor 404, includes the goal ambiguity, feedback and input ambiguity characteristics. A high value associated with the ambiguity factor 404 indicates that the inputs and outputs are not clearly specified and a low value associated with the ambiguity factor 404 indicates that the inputs and outputs are clearly specified. The third factor, the initiative factor 406, includes the worker initiative and autonomy characteristics. A high value associated with the initiative factor 406 indicates that work is structured to require much work discretion over decisions about how to do the work and a low value associated with the initiative factor 406 indicates that work is structured to allow little worker discretion over decisions about how to do the work. The fourth factor, the complexity factor 408, includes the difficulty, interaction and interdependence characteristics. A high value associated with the complexity factor 408 indicates that the work has high interdependence, requires a lot of interaction with others and is difficult to perform. In contrast a low value of the complexity factor 408 indicates that the work has low interdependence, requires little interaction with others, and is relatively simple to perform.

The four factors described herein and the characteristics associated with them are exemplary in nature and many other combinations are possible with exemplary embodiments of the present invention. Some of the factors and/or characteristics may be eliminated and others added, and other groupings of characteristics to form factors may be utilized. In general, the selection of characteristics to be measured, the questions within the scales, the scale used for a particular characteristic, the grouping into factors, and the principles applied will depend on the categories of work being analyzed. In addition, these components may be modified and improved over time within a particular division and/or company. As used herein the term “category of work” refers to one or more specific combinations of factor scores.

Referring to block 110 in FIG. 1, work categories are identified based on the factor scores. The work of a specific work group is categorized on each work factor based on its mean value relative to the average factor score of a sample of people on that factor. Work can be categorized based on its relative value on one dimension or several dimensions.

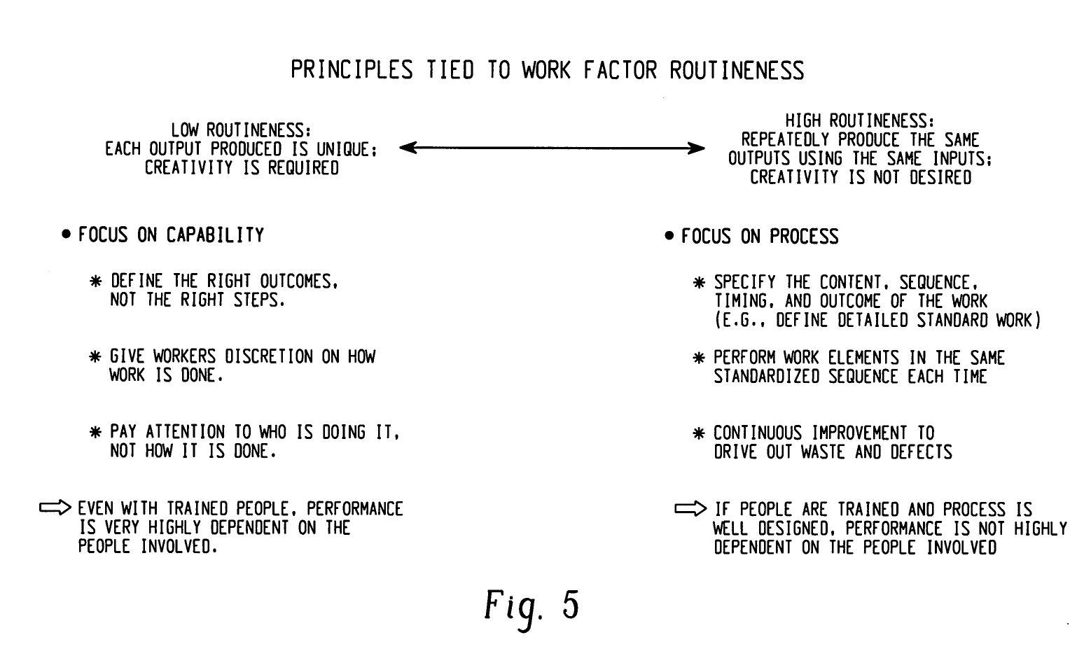

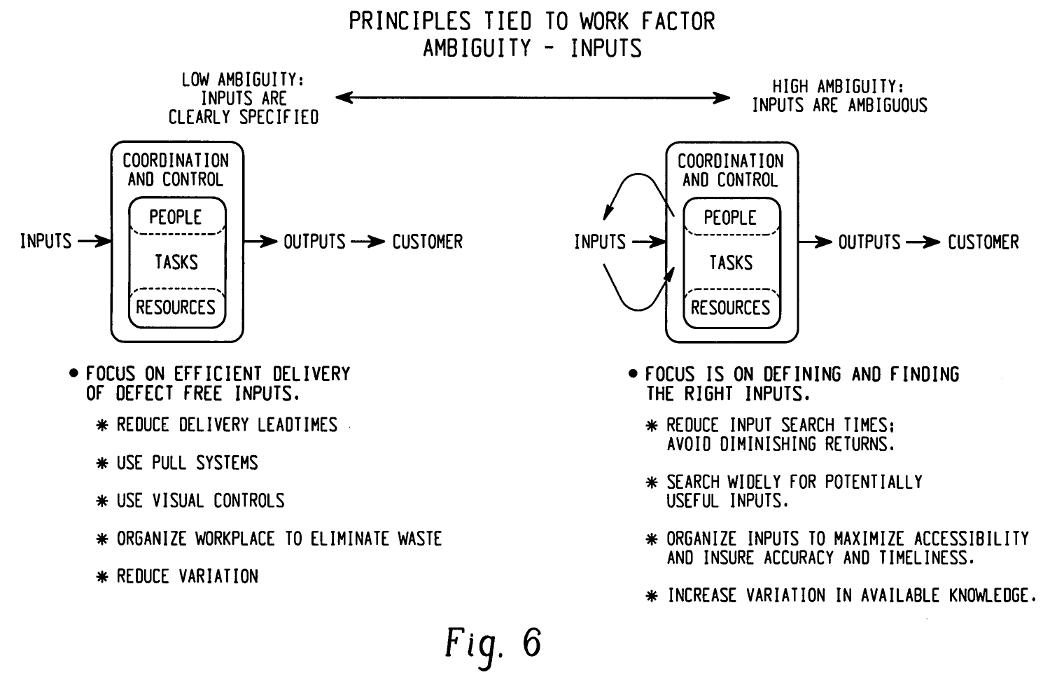

Referring back to block 112 in FIG. 1, principles are suggested and/or applied based on the work categories. In general, the principles should have practical utility; should not be obvious or be something that would happen without worker intervention; should have an opposite action; should result in poorer performance if ignored; should not dictate a process, but, rather, provide guidelines that an effective process should obey. FIG. 5 contains exemplary principles that may be applied based on the results of the survey relating to the routineness factor 402. For people performing work with a high value for the routineness factor 402, principles focusing on the process are suggested. For people performing work with a low value for the routineness factor 402, principles focusing on capability on suggested. FIG. 6 contains exemplary principles that may be applied based on the results of the survey relating to the ambiguity factor 414 and specifically the subset referred to as input ambiguity. For people performing work with a high value for the input ambiguity factor, principles focusing on defining and finding the right inputs are suggested. For people performing work characterized by a low value for the input ambiguity factor, principles focusing on efficient delivery of defect free inputs are suggested.

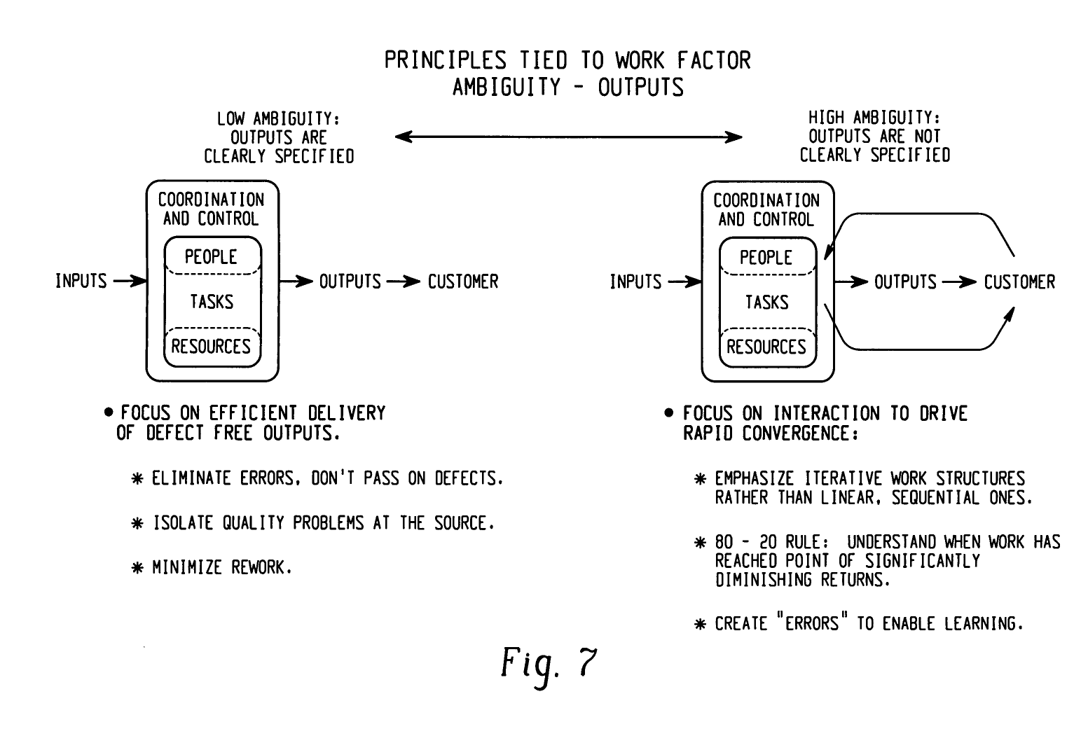

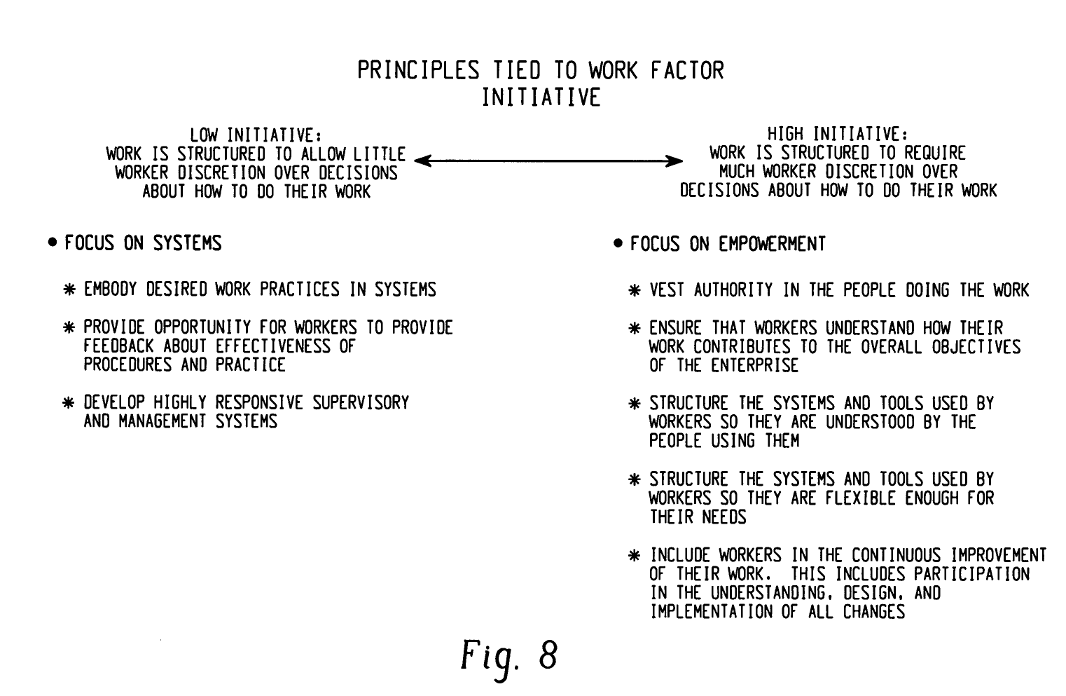

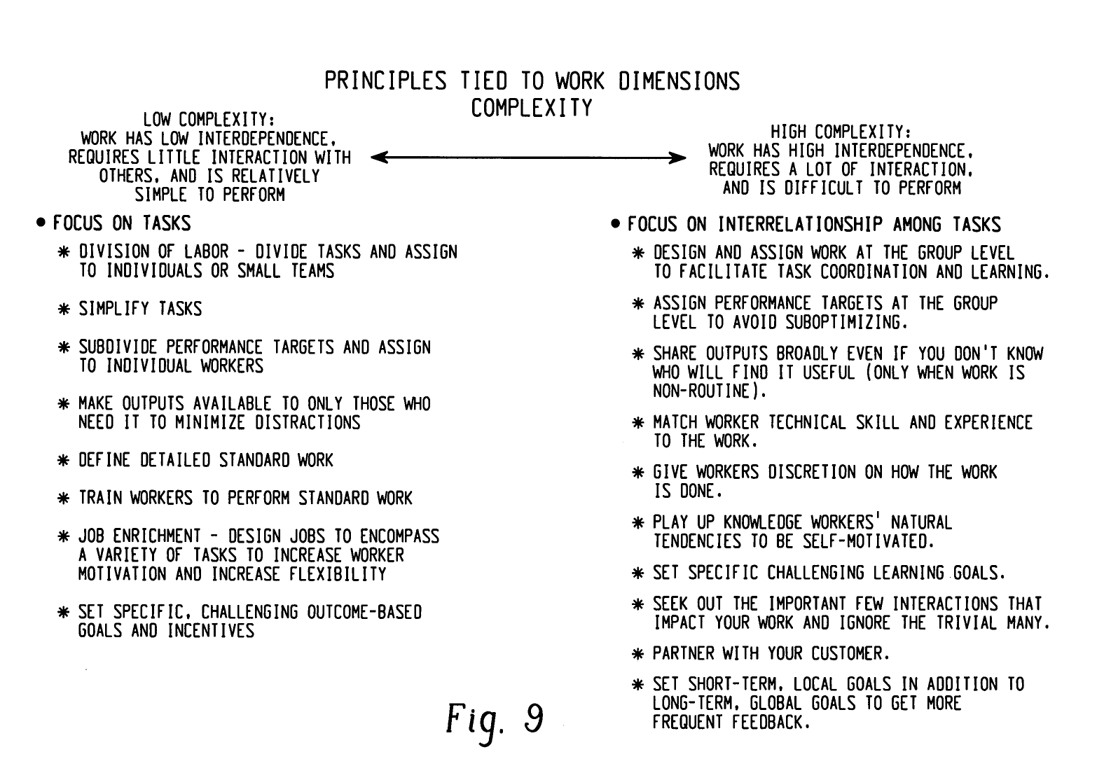

FIG. 7 contains exemplary principles that may be applied based on the results of the survey relating to the ambiguity factor 404 and specifically the subset referred to as output ambiguity. For people performing work with a high value for the output ambiguity factor, principles focusing on interaction to drive rapid convergence are suggested. For people performing work with a low value for the output ambiguity factor, principles focusing on efficient delivery of defect-free outputs are suggested. Similarly, FIG. 8 contains exemplary principles that may be applied based on the results of the survey relating to the initiative factor 406 and FIG. 9 contains exemplary principles that may be applied based on the results of the survey relating to the complexity factor 408.

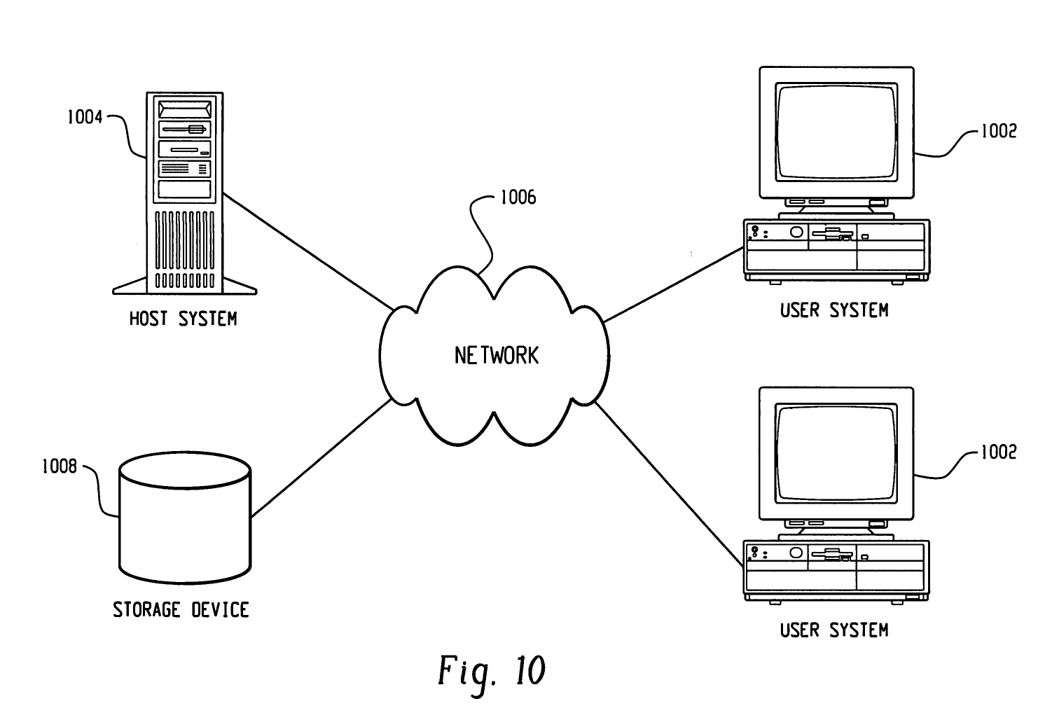

FIG. 10 is a block diagram of an exemplary system for categorizing work. The system depicted in FIG. 10 includes one or more user systems 1002 through which users at one or more geographic locations may contact the host system 1004 to take a survey (i.e., fill out a questionnaire). The host system 1004 executes computer instructions for performing blocks 102 through 108 in FIG. 1. The user systems 1002 are coupled to the host system 1004 via a network 1006. Each user system 1002 may be implemented using a general-purpose computer executing a computer program for carrying out the processes described herein. The user systems 1002 may be personal computers (e.g., a lap top, a personal digital assistant) or host attached terminals. If the user systems 1002 are personal computers, the processing described herein may be shared by a user system 1002 and the host system 1004 (e.g., by providing an applet to the user system 1002).

The network 1006 may be any type of known network including, but not limited to, a wide area network (WAN), a local area network (LAN), a global network (e.g. Internet), a virtual private network (VPN), and an intranet. The network 1006 may be implemented using a wireless network or any kind of physical network implementation. A user system 1002 may be coupled to the host system through multiple networks (e.g., intranet and Internet) so that not all user systems 1002 are coupled to the host system 1004 through the same network. One or more of the user systems 1002 and the host system 1004 may be connected to the network 1006 in a wireless fashion. In one embodiment, the network is an intranet and one or more user systems 1002 execute a user interface application (e.g. a web browser) to contact the host system 1004 through the network 1006.

The storage device 1008 includes data relating to categorizing work such as a questionnaire and the results (e.g., the responses and the categorizing) of the questionnaires. In addition, information tracking the participation rate and other administrative information may also be stored on the storage device 1008. The storage device 1008 may be implemented using a variety of devices for storing electronic information. It is understood that the storage device 1008 may be implemented using memory contained in the host system 1004 or it may be a separate physical device. The storage device 1008 is logically addressable as a consolidated data source across a distributed environment that includes a network 1006. Information stored in the storage device 1008 may be retrieved and manipulated via the host system 1004 and/or via the user system 1002. In exemplary embodiments of the present invention, the host system 1004 operates as a database server and coordinates access to application data including data stored on the storage device 1008.

The host system 1004 depicted in FIG. 10 may be implemented using one or more servers operating in response to a computer program stored in a storage medium accessible by the server. The host system 1004 may operate as a network server (e.g., a web server) to communicate with the user system 1002. The host system 1004 handles sending and receiving information to and from the user system 1002 and can perform associated tasks. The host system 1004 may also include a firewall to prevent unauthorized access to the host system 1004 and enforce any limitations on authorized access. For instance, an administrator may have access to the entire system and have authority to modify portions of the system (e.g., modify a scale). A firewall may be implemented using conventional hardware and/or software as is known in the art.

The host system 1004 may also operate as an application server. The host system 1004 executes one or more computer programs administer a questionnaire and to analyze the results. Processing may be shared by the user system 1002 and the host system 1004 by providing an application (e.g., java applet) to the user system 1002. Alternatively, the user system 1002 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

Exemplary embodiment of the present invention may be utilized to provide an assessment of the kind of work a person (or group of people) performs. Based on the assessment, a set of principles may be suggested to improve the productivity of the person (or group of people). Alternatively, the assessment may be utilized, with or without the associated principles, to train people, to train supervisors, as part of a prospective employee screening process, and/or to determine compensation plans. Training may be performed via a computer, through self-tutoring and/or through live workshops or in any other appropriate manner. By measuring the characteristics of salaried work, it may be possible to better tailor work practices and operating guidelines to better support the work. In this manner both efficiency and effectiveness.

Utilizing an exemplary embodiment of the present invention to determine the characteristics of white-collar work and then to categorize white-collar workers according to these characteristics can lead to improved principles for productivity improvement. In addition, the ability to collapse several related characteristics into a subset of factors can lead to the results being easier to understand and to a smaller number of more directed principles being suggested. Having a smaller number of more directed principles may increase the probability of the principles being understood and adopted. In addition, the method of categorization described herein is applicable across a variety of work positions (e.g., white-collar work such as engineering and non-white collar work such as manufacturing), resulting in fewer tools being required to improve productivity.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for evaluating input ambiguity, the method comprising:
receiving a response to a questionnaire from a person, the questionnaire including a plurality of questions related to an input ambiguity characteristic, wherein the questions include,
whether inputs to a work task are available,
whether the inputs to the work task are identified,
whether work task resources are identified when the work task is started,
whether the work task resources are available when the work task is started, and
whether customer requirements are understood; and
computing a score for the questions using the response from the person and the questionnaire as input.

2. The method of claim 1, further comprising developing performance improvement principles based on the score.

3. The method of claim 1, further comprising developing a training program based on the score.

4. The method of claim 3, wherein the training program is targeted to a supervisor of the person.

5. The method of claim 1, the questionnaire was sent electronically to the person.

6. The method of claim 1, further comprising transmitting the questionnaire to the person.

7. The method of claim 1, further comprising transmitting the score to the person.

8. The method of claim 1, wherein a combined score is computed for a plurality of people.

9. The method of claim 1, wherein the person is an engineer.

10. The method of claim 1, wherein the person is a manufacturing employee.

11. The method of claim 1, wherein the response includes a number along a five-point scale for each question with one indicating strongly agree and five indicating strongly disagree.

12. A computer program product for evaluating input ambiguity, the computer program product comprising:
a storage medium readable by a processing circuit and storing instructions for execution by the processing circuit for performing a method comprising:
receiving a response to a questionnaire from a person, the questionnaire including a plurality of questions related to an input ambiguity characteristic, wherein the questions include,
whether inputs to a work task are available,
whether the inputs to the work task are identified,
whether work task resources are identified when the work task is started,
whether the work task resources are available when the work task is started, and
whether customer requirements are understood; and
computing a score for the questions using the response from the person and the questionnaire as input.

13. The computer program product of claim 12, further comprising developing performance improvement principles based on the score.

14. The computer program product of claim 12, wherein a combined score is computed for a plurality of people.

15. The computer program product of claim 12, wherein the response includes a number along a five-point scale for each question with one indicating strongly agree and five indicating strongly disagree.

16. A system for evaluating input ambiguity, the system comprising:
a host system in communication with a user system, the host system including instructions for:
receiving a response to a questionnaire from a person, the questionnaire including a plurality of questions related to an input ambiguity characteristic, wherein the questions include,
whether inputs to a work task are available,
whether the inputs to the work task are identified,
whether work task resources are identified when the work task is started,
whether the work task resources are available when the work task is started, and
whether customer requirements are understood; and
computing a score for the questions using the response from the person and the questionnaire as input.

17. The system of claim 16, wherein the response includes a number along a five-point scale for each question with one indicating strongly agree and five indicating strongly disagree.
